(19) United States
(12) Patent Application Publication
(10) Pub. No.: US 2004/0071102 A1
(43) Pub. Date: Apr. 15, 2004

(54) Method and apparatus for echo cancellation

(76) Inventors: Lars-Goran Petersen, Tumba (SE); Gunnar Larsson, Tumba (SE); Patrik Wiss, Stockholm (SE); Stefan Pudas, Sundyberg (SE)

Correspondence Address: NIXON & VANDERHYE, PC, 1100 N GLEBE ROAD, 8TH FLOOR, ARLINGTON, VA, 22201-4714, US

(21) Appl. No.: 10/432,953

(22) PCT Filed: Nov. 29, 2000
(86) PCT No.: PCT/SE00/02369

(51) Int. Cl. H04B 3/20

(52) U.S. Cl. 370/286

(57) ABSTRACT

The present invention relates to an arrangement and a method for echo cancellation wherein only telecommunications traffic (s6) of a downlink (3), for which echo cancellation is performed, passes through an echo canceller function (1′). Traffic (s5) of an uplink (2) is forwarded via a switch (15) to a near end (B) without passing through the echo canceller function (1′). A signal copy (s9) of traffic (s5) of the uplink is created by the switch (15) and directed to the echo canceller function (1′) in order to serve as a base for an estimated echo signal (e′). The estimated echo signal (e′) is subtracted from the traffic (s6) of the downlink, which is input to the echo canceller function (1′), so as to create an output signal (s8), which is substantially free from echo. The invention makes it possible to reduce the processing capacity required in connection with echo cancellation and provides for a decreased delay of traffic of the uplink (2).

### FIELD OF THE INVENTION

The present invention relates to echo cancellation in general and in particular to echo cancellation in a telecommunications system.

### BACKGROUND

In a telecommunications network, e.g. PSTN, 4-wire connections are in general used in the transport part of the network and 2-wire connections are used in the access part. In the interface between the transport part and the access part is a hybrid used, which is responsible for the conversion from 4-wire to 2-wire and vice versa. Impedance mismatches in the hybrid may lead to leaking of speech energy back to a talking person, who perceives the phenomena as echo. The main cause of echo in telecommunications networks is imperfect impedance matching in the interface between 4-wire and 2-wire.

As long as the delay of the transmission path is short, the talking person will not be disturbed by the reflected speech energy since it then blends with the normal sidetone. However if the delay is increased so that the reflected speech energy becomes separated from the sidetone, it becomes noticeable and it is in that case preferable to perform echo cancellation.

A considerable delay is always present in digital cellular systems. This delay is due to the speech and channel coding necessary for radio transmission. Therefore echo cancellation is always performed for speech connections between two end users where one end user is connected to a digital cellular network and the other end user is connected to a telecommunications network, e.g. PSTN, via a 2-wire access line.

Echo cancellation is performed by means of an echo canceller, which is a resource, put into the transmission line between the two end users. In order to obtain as efficient echo suppression as possible the echo canceller should be placed as close to the conversion point as possible at a speech receiving side. This means that for a call where both end users have a two-wire access to a telecommunications network two echo cancellers are usually used, one in connection with each end users conversion point.

As mentioned above echo is reflected voice energy from a first direction of a voice connection that appears on a second direction of the voice connection. Traditional echo cancellers have a first and a second input signal and a first and a second output signal. The first input signal and output signal are associated with telecommunications traffic in the first direction and the second input signal and output signal are associated with the telecommunications traffic in the second direction. The main part of an echo canceller is an echo canceller algorithm. Based on the first input signal the echo canceller algorithm produces a replica of the echo component in the second input signal. This replica becomes an estimated echo signal. The estimated echo signal is subtracted from the second input signal in order to, ideally, make the second output signal free from echo.

More information regarding the problem of echo and the idea of echo cancellation can be found in the article A Eriksson et al, “Ericsson echo cancellers—a key to improved speech quality”, Ericsson Review No. 1, 1996.

Information on echo cancellation in connection with packet switched networks can be found in the U.S. Pat. No. 5,875,246 and in the international patent application WO 00/25487.

### SUMMARY OF THE INVENTION

In order for an echo canceller to perform its task, processing capacity is required. The echo canceller function is usually implemented in a Digital Signalling Processor software, but it can also be implemented in some other type of processing resource. Processing capacity is a limited resource and it is therefore of interest to use the available processing capacity as efficiently as possible. The present invention solves the problem of making the utilisation of processing capacity in connection with echo cancellation more efficient.

An object of the present invention is thus to provide a telecommunications system and a method for echo cancellation, which demand less processing capacity from a processing resource involved in echo cancellation, than prior art solutions.

The present invention solves the above stated problem by means of a telecommunications system as stated in claim 1, and by means of a method for echo cancellation as stated in claim 8.

As described above traditional echo cancellers have a first and a second input signal and a first and a second output signal, where the first input and output signals are associated with telecommunications traffic in a first direction and the second input and output signals are associated with telecommunications traffic in a second direction. The task of the echo canceller is to cancel echo contained in the telecommunications traffic in the second direction. The echo canceller will for this purpose produce an estimated echo signal based on the telecommunications traffic in the first direction. In prior art echo cancellers, both directions of a duplex telecommunications connection, for which echo cancellation is needed, pass through the echo canceller, even though the echo canceller only cancels echo in one of the directions. According to the present invention only telecommunications traffic in the second direction, for which echo cancellation is performed, pass through an echo canceller function. A switch forwards the traffic in the first direction directly to a near end destination without passing the echo canceller function. The switch further forwards a signal copy of the traffic in the first direction to the echo canceller function in order for the signal copy to serve as a base for the estimated echo signal. This signal copy is however not intended for further forwarding and the echo canceller function will thus not have to provide for output of the signal copy. Processing capacity is thus saved in a processing resource involved in echo cancellation since, according to the invention the processing resource will not have to deal with the unnecessary handling of output of telecommunications traffic in the first direction. It is unnecessary to involve the echo canceller function in the handling of the output of telecommunications traffic in the first direction since no echo cancellation is performed in the first direction and the simple forwarding of the traffic in the first direction can be handled by other parts of a telecommunications system, which are better suited for this purpose, such as the switch.

An advantage of the present invention is that it, as mentioned, reduces the processing capacity required for performing echo cancellation.

A further advantage of the present invention is that it allows for complete separation of the two directions of telecommunications traffic in a connection. This provides for flexibility in the configuration of a telecommunications system and makes it possible to e.g. place the echo canceller function and the switch for forwarding the telecommunications traffic in the first direction in separate nodes.

Yet another advantage of the present invention is that it is easy to implement. It is in many cases possible to make use of an already existing point-to-multipoint mechanism in a switch in the telecommunications system in order to implement the present invention in a simple way.

Another advantage according to the present invention is that it makes it possible to accept some delay in the signal copy of the traffic in the first direction that is input to the echo canceller function. It is therefore possible to allow the use of a non-real time connection for this input signal.

An advantage of an embodiment of the present invention is that it reduces the delay of the telecommunications traffic in the first direction in a packet- or cell-switched telecommunications network. The reduced delay means that the speech quality is improved.

The present invention will now be described in more detail by means of preferred embodiments and with reference to the accompanying drawings.

### BRIEF DESCRIPTION OF THE DRAWINGS

FIG. 1 is a schematic block diagram of an echo canceller function according to known technology.

FIG. 2 is a schematic block diagram of a processing unit that implements an echo canceller function according to known technology.

FIG. 3 is a schematic block diagram of an arrangement for echo cancellation according to the present invention.

FIG. 4a and FIG. 4b are block diagrams illustrating alternative connections between an echo canceller function, a switch and a near end.

FIG. 5 is a schematic block diagram of a processing unit that implements an echo canceller function according to the present invention.

FIG. 6 is a schematic block diagram of an alternative embodiment of a processing unit that implements an echo canceller function according to the present invention.

FIG. 7 is a flow diagram of a method for echo cancellation according to the present invention.

### DETAILED DESCRIPTION

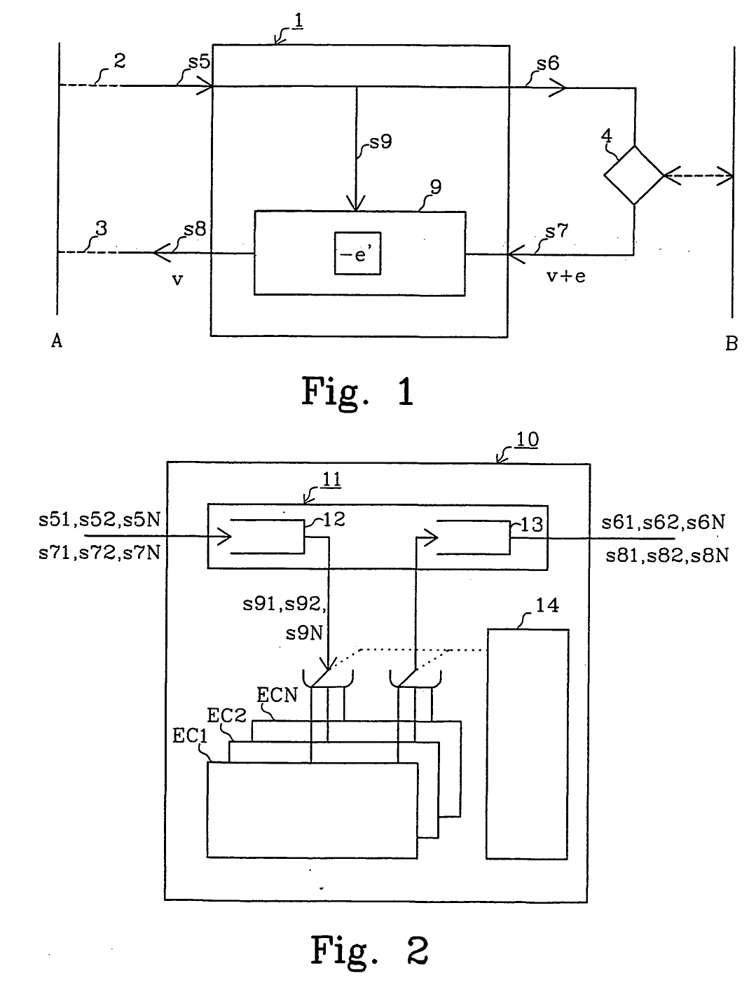

FIG. 1 shows an echo canceller function 1, according to prior art. The echo canceller function 1 is inserted between a far end A and a near end B. The task of the echo canceller function is to suppress echo on a voice connection set up between the far end A and the near end B. The speech connection has an uplink 2, which includes traffic from the far end A to the near end B, and a down link 3, which includes traffic from the near end B to the far end A. As mentioned above the echo canceller function should be placed as close to a conversion point, i.e. a hybrid, as possible at a speech receiving side in order to obtain as efficient echo suppression as possible. The echo canceller function 1 is placed near a hybrid 4 associated with the near end B and its object is to cancel echo on the downlink 3. It is possible that there is a second hybrid (not shown) associated with the far end A. In that case a second echo canceller function would probably be placed near the second hybrid with the object of cancelling echo on the uplink 2.

Both the uplink 2 and the downlink 3 pass through the echo canceller function 1. The echo canceller function has a first input signal s5 and a first output signal s6 for traffic associated with the uplink 2, and a second input signal s7 and a second output signal s8 for traffic associated with the downlink 3. Since the echo canceller function does not perform any echo cancellation or other type of signal processing on the uplink the first input signal s5 has the same appearance as the first output signal s6. The traffic of the uplink 2 will however experience delay caused by the echo canceller function, so the first output signal s6 will be a delayed version of the first input signal s5.

The cancelling of echo on the downlink is performed in the echo canceller function by means of an echo canceller algorithm 9, which can be seen as the main part of the echo canceller function. Echo on the downlink 3 will appear as an echo component e that is superimposed on normal voice traffic v of the second input signal s7. The echo canceller algorithm 9 produces a replica of the echo component e in the second input signal s7. This replica becomes an estimated echo signal e′. The estimated echo signal e′ is subtracted from the second input signal s7 in order to, ideally, make the second output signal s8 free from echo. The aim is thus to make the estimated echo signal e′ identical to the echo component e. FIG. 1 illustrates this ideal situation. As mentioned above the echo component e is reflected voice energy from the uplink 2. Information regarding the appearance of the echo component e, at a particular moment, can thus be retrieved from the appearance of the first input signal s5 at an earlier moment. It is therefore advantageous for the echo canceller algorithm to base the estimated echo signal e′ on the first input signal s5. A copy s9 of the first input signal is therefore fed to the echo canceller algorithm.

The description above of the echo canceller function 1 and of how echo cancellation is performed is here simplified. The detailed functioning and appearance of an echo canceller function, as outlined with reference to FIG. 1, is however well known to a person skilled in the art.

The echo canceller function 1 can be said to be balanced since both the uplink and the downlink are taken through the echo canceller function. The echo canceller function 1 is usually implemented in a processing unit 10, wherein many echo canceller functions are instantiated, as shown FIG. 2. In FIG. 2 are echo canceller instances EC1, EC2 and ECN shown, but as the notation indicates the number of instances may vary. Each echo canceller instance includes an echo canceller algorithm that works to cancel echo on second input signals s71, s72 and s7N respectively. Analogously with what was shown in FIG. 1, the processing unit will also have first input signals s51, s52 and s5N, first output signals s61, s62 and s6N and second output signals S81, S82 and s8N. The first input signal s51 and the first output signal s61 are associated with an uplink of a first voice connection. The second input signal s71 and second output signal s81 are associated with a downlink of the first voice connection. In a corresponding manner are the signals s52, s62, s72 and s82, associated with up- and downlink of a second voice connection, and the signals s5N, s6N, s7N and s8N are associated with a N:th voice connection. The processing unit 10 has a common I/O logic 11 that includes a FIFO (First In First Out) input queue 12 and a FIFO output queue 13. Voice traffic associated with the first and second input signals will upon entrance in the processing unit be placed in the FIFO input queue, and voice traffic associated with the first and second output signals will before it exits the processing unit be placed in the FIFO output queue. The voice traffic placed in the queues will in the case of a packet-switched environment be in the form of voice packets and in the case of a circuit-switched environment be in the form of voice information units extracted from timeslots. We will for simplicity refer to the voice traffic in the queues as voice packets in the following, even for the case of a circuit-switched environment.

The processing 10 unit further includes a processor scheduler 14, which controls the forwarding of voice packets between the queues 12, 13 and to and from the echo canceller instances EC1, EC2, ECN. The voice packets in the FIFO input queue 12 are processed in order. Voice packets associated with the second input signals s71, s72, s7N are to be forwarded to the echo canceller instances EC1, EC2, ECN, where echo contained in the voice packets is to be suppressed as explained above. After echo cancellation the processed voice packets are forwarded to the FIFO output queue 13 where they have to await their turn to exit the processing unit 10 and thereby form the second output signals s81, s82, s8N.

The voice packets that are associated with the first input signals s51, s52, s5N should simply be shuffled from the FIFO input queue 12 to the FIFO output queue 13 in order to form the first output signals s61, s62, s6N upon exit from the FIFO output queue 13. Copies s91, s92, s9N of the voice packets associated with the first input signals s51, s52, s5N should however be forwarded to the echo canceller instances EC1, EC2, ECN in order to serve as a base for the estimated echo signals.

A disadvantage with this arrangement is that the shuffling of voice packets associated with the first input signals s51, s52, s5N requires unnecessary processing capacity from the processing unit 10 and further adds an unnecessary delay to these voice packets. The unnecessary delay of voice packets associated with the first input signals s51, s52, s5N is caused by the fact that these packets will have to wait in the queues 12, 13 for other packets ahead in the queue to be processed first. Voice packets associated with the first and second input signals and output signals are all placed in the same input and output queues and the queues will thus include a mix of packets associated with the different signals. In a circuit-switched environment where timing is crucial provisions and scheduling will have to have been made in advance in order to control that the unnecessary delay of packets associated with the first input signals, in principle, is kept at a constant level and does not exceed a maximum delay. However in a packet switched environment, where packets are not ordered into time slots, the unnecessary delay may become large and may thus have a considerable impact on the performance of the system and may deteriorate the speech quality. It is possible to make arrangements to monitor and modify the queuing system to ascertain that voice packets associated with the first input signals are given some kind of priority when passing through the processing unit, in order to keep the unnecessary delay down. These types of arrangements will however require an increased processing capacity from the processing unit 10. There is thus clearly a trade off between delay and processing capacity.

As will be described below however the present invention provides a solution where both the processing capacity required in the processing unit and the delay of voice packets, caused by echo cancellation, is decreased at the same time.

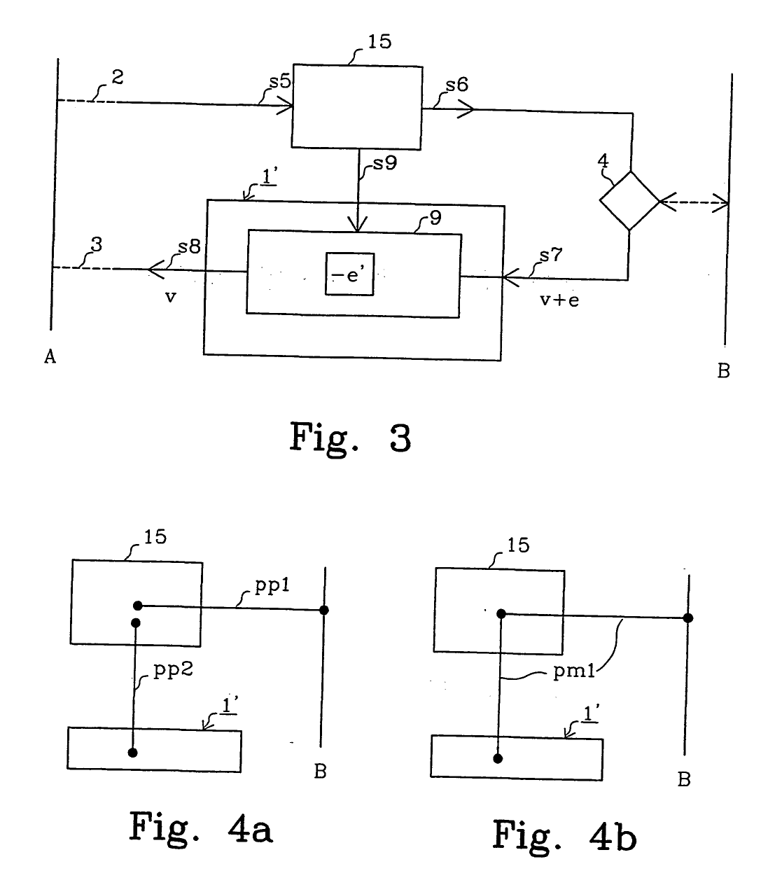

FIG. 3 shows part of a telecommunications system that illustrates an arrangement according to the present invention. FIG. 3 resembles the arrangement shown in FIG. 1, why like reference numerals are used for corresponding features in the two figures. FIG. 3 shows an inventive echo canceller function 1′, located between the far end A and the near end B. The echo canceller functional differs from the echo canceller function 1 in FIG. 1 in that the uplink 2 does not pass through the echo canceller function 1′. The uplink 2 will instead pass through a switch 15, which switches the copy s9 of the first input signal s5 to the echo canceller function 1′ and which forwards the uplink 2 directly to the near end B by means of outputting the first output signal s6 so that it does not pass through the echo canceller function 1′. Since the uplink 2 is not taken across the echo canceller function 1′ it will not experience delay introduced by the echo canceller function and the processing capacity required by the echo canceller function will decrease since it will no longer have to use processing capacity in order to output the first output signal s6. The reason for the capacity gain will be explained in further detail below.

The intention of the present invention is to make use of a switch that already is present in the telecommunications system. The switch 15 may be a TDM-switch in a circuit-switched telecommunications system or a packet- or cell-switch in a packet-switched telecommunications system. Since the switch is particularly suited for forwarding traffic it will be able to work much faster than the echo canceller function to output the first output signal s6, so that the delay on the downlink is considerably decreased with means of the inventive arrangement. This decreased delay will maybe not affect the performance of a circuit-switched telecommunications system much, but it can have a great impact in a packet-switched telecommunications system, where it can improve speech quality.

The switch 15 will have to be able to distribute the first input signal s5 to produce a first output signal s6 to be forwarded directly to the near end B and a copy s9 to be forwarded to the echo canceller function 1′. This can be accomplished by the switch 15 by establishing a first point-to-point connection pp1 between the switch and the near end B and a second point-to-point connection pp2 between the switch and the echo canceller function 1′, as shown in FIG. 4a. Alternatively a point-to-multipoint connection pml may be established between the switch 15 and the near end B and the echo canceller function 1′, as shown in FIG. 4b. A point-to-multipoint mechanism is a simple mechanism that is implemented in many existing switches today. If an already existing point-to-multipoint mechanism can be utilised the implementation of the present invention becomes particularly easy.

The present invention allows for a complete separation of the uplink 2 and the downlink 3. The switch 15 can be housed in the same node as the echo canceller function 1′ or anywhere in the telecommunications network as long as it is located before the conversion from 4-wire to 2-wire in the hybrid 4.

The copy s9 of the first input signal s5, which is directed to the echo canceller function 1′, is not very sensitive to delay. A delay on the copy s9 will not affect the overall delay of the traffic to or from the near end B. It is only important that a section of the copy s9 reaches the echo canceller algorithm 9 before the echo component e, which originates from the section, reaches the echo canceller algorithm, so that the copy s9 can be used, as intended, for cancelling out the echo component e. Since echo cancellation only is necessary when the echo is delayed so that it becomes separated from the sidetone, as described above, it is possible to accept some delay on the copy s9. It is thus in many applications possible to accept a non-real time connection between the switch 15 and the echo canceller function 1′. The quality of service requirements on the non-real time connection can be low so that both a substantial delay as well as delay variation can be allowed. It is advantageous to use the non-real time connection since this makes it possible optimise the use of resources in the network so that priority is given to traffic, which is sensitive to delay in a time critical situation.

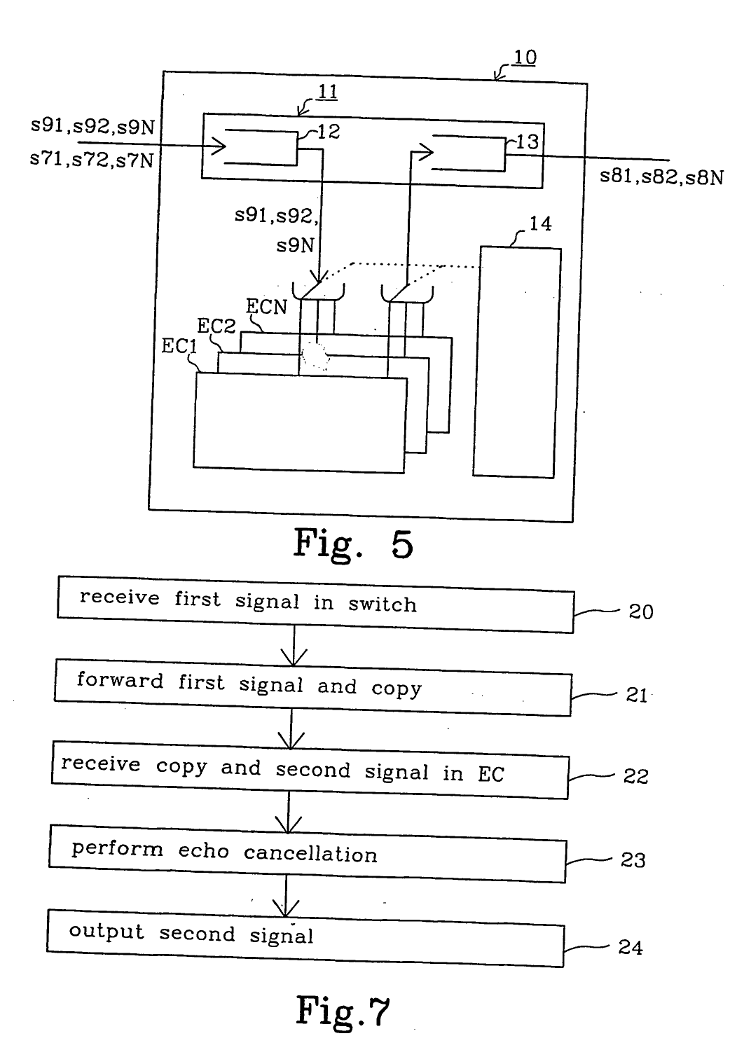

FIG. 5 demonstrates the differences in the processing unit 10 shown in FIG. 2 when the inventive arrangement shown in FIG. 3 is used compared with the previously known arrangement shown in FIG. 1. The differences arise in the input and output queues 12, 13. Since the uplink 2 is not taken through the echo canceller function (and thus not through the processing unit 10) according to the present invention, there will be no voice packets in the input queue 12 that are associated with the first input signals s51, s52 and s5N, and there will be no voice packets in the output queue 13 that are associated with the first output signals s61, s62 and s6N. The only voice packets that will pass through the output queue will be the voice packets associated with the second output signals s81, s82, s8N, which means that less voice packets will have to be processed in connection with the output queue 13 than was the case with the arrangement shown in FIG. 1. Since fewer packets have to be processed less processing capacity is required with the arrangement according to the present invention, shown in FIG. 3. Since the voice packets associated with the second output signals s81, s82, s8N no longer will have to wait for voice packets associated with the first output signals s61, s62, s6N to be removed from the output queue 13 before them, it is also possible to decrease the delay on the second output signals s81, s82, s8N according to the present invention. This decreased delay will however be small in significance compared to the delay decrease that is a result of that the wait time in the input and output queues 12, 13 is completely removed for the first input signals s51, s52, s5N, according to the present invention. The number of voice packets that has to be processed in the input queue 12 will not change according to the present invention since the voice packets associated with the first input signals s51, s52, s5N are replaced in the input queue 12 by voice packets associated with the corresponding copies s91, s92 and s9N.

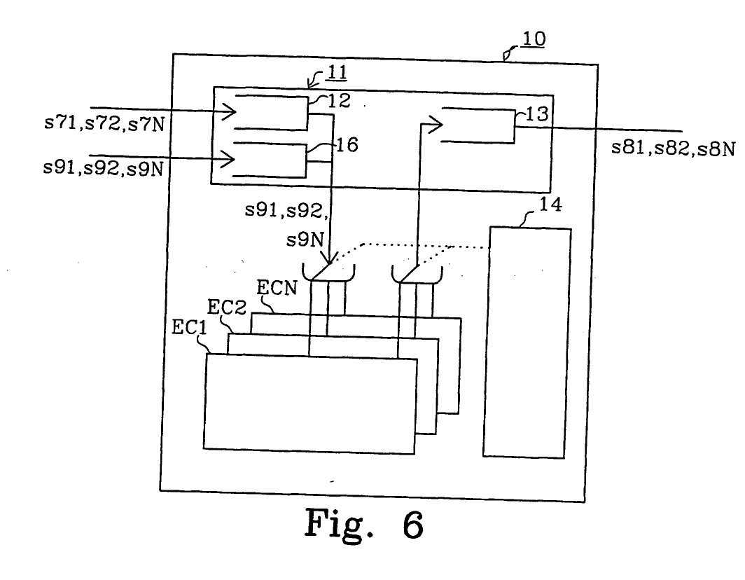

As mentioned above the copy s9 of the first input signal s5, which is directed to the echo canceller function 1′, is not very sensitive to delay. It is therefore possible to give the packets associated with the copies s91, s92, s9N lower priority than the packets associated with the second input signals s71, s72, s7N in the processing unit. This can be accomplished e.g. by placing the packets associated with the copies s91, s92, s9N in a low priority input queue separate from the input queue in which the packets associated with the second input signals s71, s72, s7N are placed. A processing unit 10′ including such a low priority input queue 16 is shown in FIG. 6. The processing unit 10′ may work such that packets in the input queue 12 are processed before packets in the low priority input queue 16 are processed. The packets in the low priority input queue 16 are only processed when the input queue 12 is empty. The processing unit 10′ ensures that the packets associated with the second input signals s71, s72, s7N are not unnecessarily delayed due to the fact that the not so delay sensitive packets associated with the copies s91, s92, s9N may have come in sooner to the input queue 12.

FIG. 7 is a flow diagram of a method for echo cancellation according to the present invention. In a first step 20 is the first input signal associated with the uplink directed to and received in the switch. Thereafter are voice packets associated with the first input signal copied and forwarded towards the near end B and to the echo canceller function, step 21. In a step 22 are the voice packets of the copied first input signal and of the second input signal, associated with the downlink, received in the echo canceller algorithm of the echo canceller function. The echo canceller algorithm perform echo cancellation on the voice packets of the second stream with use of the voice packets of the copied first input signal, so as to produce voice packets substantially free from echo, step 23. The voice packets that are substantially free from echo are then forwarded towards the far end in step 24.

As has become apparent from the above description the present invention provides an unbalanced echo canceller function 1′, where only the downlink 3, on which echo cancellation is to be performed, passes through the echo canceller function 1′. The inventive arrangement for echo cancellation makes it possible to decrease the processing capacity required in a processing unit 10 in which the echo canceller function 1′ is implemented. The present invention further provides for a decreased delay due to echo cancellation on the uplink 2, which may lead to an improvement in speech quality, particularly in packet-switched telecommunications networks.

1. A telecommunications system, which includes means for forwarding traffic in a first direction from at least one far end to at least one near end;
means for forwarding traffic in a second direction from the at least one near end to the at least one far end;
means for echo cancellation, which means for echo cancellation includes an echo canceller function arranged to perform echo cancellation of echo superimposed on the traffic in the second direction so as to make the traffic in the second direction substantially free from echo; and
a switch,
characterised in that the switch is arranged to forward the traffic in the first direction to the near end, and to produce a copy of the traffic in the first direction, and in that the switch is further arranged to forward the copy to the echo canceller function, for use in the echo cancellation of the echo superimposed on the traffic in the second direction.

2. The telecommunications system according to claim 1, characterised in that the switch is located a first node separate from a second node, in which the echo canceller function is located.

3. The telecommunications system according to any of claims 1 and 2, characterised in that the switch includes means for setting up a point-to-multipoint connection with the near end and with the echo canceller function, for the purpose of forwarding the traffic in the first direction to the near end and the copy to the echo canceller function.

4. The telecommunications system according to any of claims 1 and 2, characterised in that the switch includes means for setting up a first point-to-point connection with the near end, for the purpose of forwarding the traffic in the first direction to the near end, and means for setting up a second point-to-point connection with the echo canceller function, for the purpose of forwarding the copy to the echo canceller function.

5. The telecommunications system according to claim 4, characterised in that the second point-to-point connection is a non-real time connection.

6. The telecommunications system according to any of claims 1-5, characterised in that the echo canceller function includes means for giving the traffic in the second direction priority over the copy of the traffic in the first direction in the processing of traffic in the echo canceller function.

7. The telecommunications system according to any of claims 1-6, characterised in that the switch is a TDM-switch.

8. The telecommunications system according to any of claims 1-6, characterised in that the switch is a packet-switch.

9. A method for echo cancellation in a telecommunications system, which telecommunications system includes means for forwarding traffic in a first direction from at least one far end to at least one near end;
means for forwarding traffic in a second direction from the at least one near end to the at least one far end;
which method includes the steps of receiving in an echo canceller function the traffic in the second direction; and
performing echo cancellation, in the echo canceller function, of echo superimposed on the traffic in the second direction so as to make the traffic in the second direction substantially free from echo
characterised by the method further including the steps of
receiving the traffic in the first direction in a switch;
the switch producing a copy of the traffic in the first direction;
the switch forwarding the traffic in the first direction to the near end; and
the switch forwarding the copy to the echo canceller function, for use in the echo cancellation of the echo superimposed on the traffic in the second direction.

10. The method according to claim 9, characterised by the switch being located a first node separate from a second node, in which the echo canceller function is located.

11. The method according to any of claims 9 and 10, characterised by the method including the further step of the switch setting up a point-to-multipoint connection with the near end and with the echo canceller function, for the purpose of forwarding the traffic in the first direction to the near end and the copy to the echo canceller function.

12. The method according to any of claims 9 and 10, characterised by the method including the further steps of the switch setting up a first point-to-point connection with the near end, for the purpose of forwarding the traffic in the first direction to the near end, and of switch setting up a second point-to-point connection with the echo canceller function, for the purpose of forwarding the copy to the echo canceller function.

13. The method according to claim 12, characterised by the second point-to-point connection being a non-real time connection.

14. The method according to any of claims 9-13, characterised by the echo canceller function giving the traffic in the second direction priority over the copy of the traffic in the first direction in the processing of traffic in the echo canceller function.

15. The method according to any of claims 9-14, characterised by the switch being a TDM-switch.

16. The method according to any of claims 9-14, characterised by the switch being a packet-switch.
